(19) United States
(12) Patent Application Publication
(10) Pub. No.: US 2004/0005154 A1
(43) Pub. Date: Jan. 8, 2004

(54) Optical transmitter

(76) Inventor: Robert I. MacDonald, Manotick (CA)

Correspondence Address: JDS Uniphase Corporation, Intellectual Property Dept., 3000 Merivale Road, Ottawa, ON, K2G 6N7, CA

(21) Appl. No.: 10/318,269

(22) Filed: Apr. 29, 2003

Related U.S. Application Data
(60) Provisional application No. 60/393,810, filed on Jul. 8, 2002.

(51) Int. Cl. H04B 10/04

(52) U.S. Cl. 398/198; 398/182

(57) ABSTRACT

A method and apparatus for introducing a monitoring signal on an optical information signal for maintaining the correct bias condition of an interferometric modulator. A dither signal is introduced into the optical signal that is output from the modulator. This composite signal is detected by tapping off a portion of the modulated light, and monitored in the output of an optical receiver that receives the tapped light. By suitable processing of the detected portion of the signal output from the modulator the information required to determine whether the bias is correct, and how to alter the bias voltage if it is not, is obtained and used to control the bias voltage.

This application claims priority from U.S. provisional application No. 60/398,810, filed Jul. 8, 2002

### FIELD OF THE INVENTION

The present invention relates to an optical transmitter for use in optical communications systems, and more particularly to an optical transmitter apparatus having an interferometric modulator external to the light source and a method for its control.

### BACKGROUND OF THE INVENTION

Optical transmitters with interferometric external modulators typically include a laser diode source of optical power and a controllable interferometer. The output of the laser diode is stabilized in wavelength and power. Light emitted from the laser diode is incident on the controllable interferometer, such as a Mach-Zehnder interferometer consisting of a branching optical waveguide for separating the light to be modulated into two portions of substantially equal power, coupled to two optical paths leading from the branching device. The two optical paths are generally of essentially the same physical length. One or both of them is provided with a means to modulate its optical length. The two paths are coupled at their output ends to a combining device for recombining into a single output the light that has passed each path. Such Mach-Zehnder modulators are usually configured as waveguides in an electro-optical material in which the optical path length through a waveguide section can be controlled by means of the sensitivity of the material's refractive index to an applied electric field. Lithium niobate or various compositions of quaternary semiconductors that may be compatible with the fabrication of the laser itself are materials commonly used. Diffused or ridge waveguide structures may be used. The electric field for controlling optical path length results from a voltage signal applied to an electrode or electrodes associated with the two optical paths between the branching and combining devices. It is known that in modulator devices of this type, the modulation of the optical path can be arranged to yield no wavelength chirping or a desired form and degree of wavelength chirping.

Typically the signal with which the light is to be modulated is binary and consists of two voltage levels. It is desirable to obtain the greatest possible ratio of transmissions between the transmissive and non-transmissive states of the modulator (extinction ratio) in order that the modulation of the light be as great as possible. In order to obtain maximum extinction ratio, one of the applied voltage levels should be near the voltage that yields maximum transmission and the other near the voltage yielding minimum transmission through the interferometer. The applied digital signal will then have an average voltage that is near the middle of the voltage—transmission characteristic of the interferometer. This average voltage is called the “bias point”. If analog rather than digital signals are to be transmitted, the bias point corresponds to the average voltage in the signal and the maximum and minimum transmission voltages correspond to the peaks of the applied signal.

The modulation transfer function of a typical interferometric modulator is shown in FIG. 1 with the bias point indicated and the mapping between a typical digital input voltage signal and output optical signal shown. It is important to note that the transfer function is periodic in voltage because the interferometer cycles through more than one order of interference as the drive voltage is monotonically increased. The shape of the transfer function is sinusoidal in principle. In consequence of this periodicity, there is an approximately linear portion of the transfer function containing the bias point, but at voltages sufficiently far from the bias point the sensitivity of the optical modulation to applied voltage abates, passes through zero, and reverses sign.

One known difficulty of interferometric modulators is the problem of ensuring that the average of the modulation signal corresponds to the best bias point for the modulator. With temperature, aging and other effects the voltage that corresponds to the optimum bias point may shift. It is desirable to provide a method whereby the modulation performance of the transmitter can be monitored and the bias voltage corrected if need be. Such a system is described in U.S. Pat. No. 5,170,274 assigned to Fujitsu Ltd., Kawasaki, Japan, and reissued as Re 36,088, which are incorporated by reference herewith. It is shown in these patents that the bias can be maintained at a correct level by monitoring a small, periodic signal which shall be referred to as the “dither” signal that is imposed on the information signal to be transmitted before it in turn is applied to the modulator to generate the optical signal. The result is a voltage signal that consists of the signal to be transmitted, with a small modulation of its envelope consisting of the dither signal. The dither signal modulates the information signal so that each side of the envelope of the information signal is varied at equal amplitudes and in opposite phases to correspond to the dither signal , as shown in FIG. 2. This composite signal is applied to the modulator, imposed on the light, detected by tapping off a portion of the modulated light, and monitored in the output of an optical receiver that receives the tapped light.

When the bias is correct the monitored signal does not contain a component at the dither frequency because the average power of the optical signal is constant. However, if the bias voltage is too high, the modulation of the upper side of the information signal envelope is far enough from the bias point to be reduced or even inverted in polarity, following the nonlinearity of the transfer function in this region. In such a situation the monitor signal does contain a component at the dither frequency. Hence the presence of a dither component in the monitor signal indicates that a correction should be made to the bias voltage. If the bias voltage is too low, the dither signal on the lower side of the envelope is compressed or inverted and in this situation too there is a component in the monitor signal at the dither frequency. It is in opposite phase by comparison with the situation when the bias point is too high, thus there is a means of knowing in what direction the correction to the bias voltage should be made. The presence of the dither component in the monitored signal and its polarity can be detected by homodyne detection whereby the monitor signal is multiplied by the dither signal. The presence of a dither component is indicated by a constant voltage from the homodyne process, with the polarity of the voltage indicating the polarity of the dither component.

While the method described in U.S. Pat. No. 5,170,274 succeeds in providing a monitoring signal that indicates a bias error and a direction for the bias correction, it suffers from complexity of implementation. The dither signal must be imposed on the information signal in such a way that the two sides of the signal envelope are of equal amplitudes and in antiphase. The simplest method consists of adding the dither signal to a constant voltage and multiplying the result with the information signal. Electronic multiplying circuits for adding the dither signal to a bias and multiplying it with the information signal are required in addition to the Mach-Zehnder driver amplifier and the dither signal generation circuit.

It is an object of this invention to provide a simpler method and apparatus for introducing a monitoring signal on an optical information signal for maintaining the correct bias condition of an interferometric modulator.

It is an object of this invention to eliminate the need for electronic multipliers. In one embodiment, the monitor signal can be applied simply by means of a second drive electrode in the Mach-Zehnder interferometer.

### SUMMARY OF THE INVENTION

In accordance with one aspect of the invention, there is provided an optical modulator comprising:

an optical interferometer having first and second branch paths between and optically coupled with an input port and an output port;

first electronic means for varying an optical path length between the input port and the output port in dependence upon an information signal;

second electronic means of varying an optical path length between the input port and the output port in dependence upon a dither signal;

wherein variations of optical path length produced by first electronic means and second electronic means combine linearly to produce a net phase difference after combining.

In accordance with another aspect of the invention, there is provided a method of controlling a modulator having control circuitry, the method comprising the steps of:

providing a dither signal to one of the modulator and control circuitry coupled to the modulator;

providing an information signal to one of the modulator and control circuitry coupled to the modulator, summing the dither signal and an information signal to yield a control signal; and,

utilizing at least a portion the control signal to control the modulator in a feed-back loop.

### BRIEF DESCRIPTION OF THE DRAWINGS

Exemplary embodiments of the invention will now be described in conjunction with the drawings in which:

FIG. 1 illustrates the modulation transfer function of a conventional interferometric modulator,

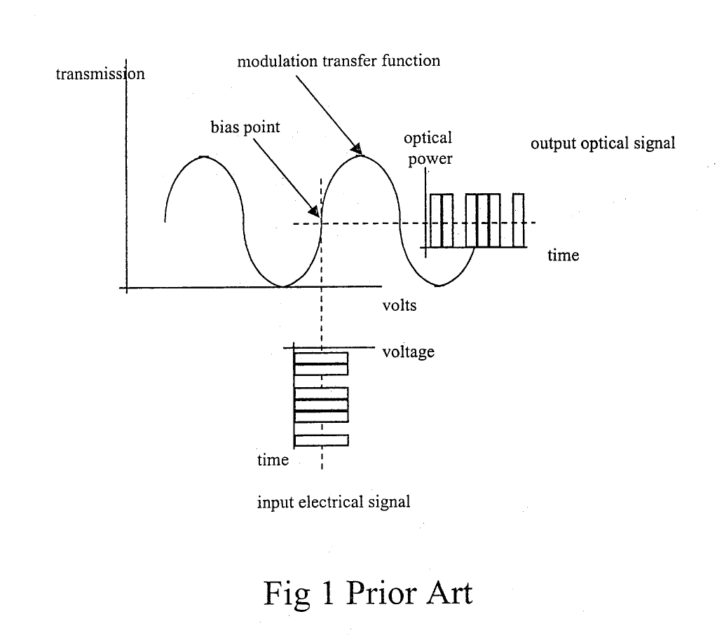

FIG. 2 illustrates the modulation of the information signal by a dither signal according to the prior art wherein each side of the information signal envelope is varied in opposite phases,

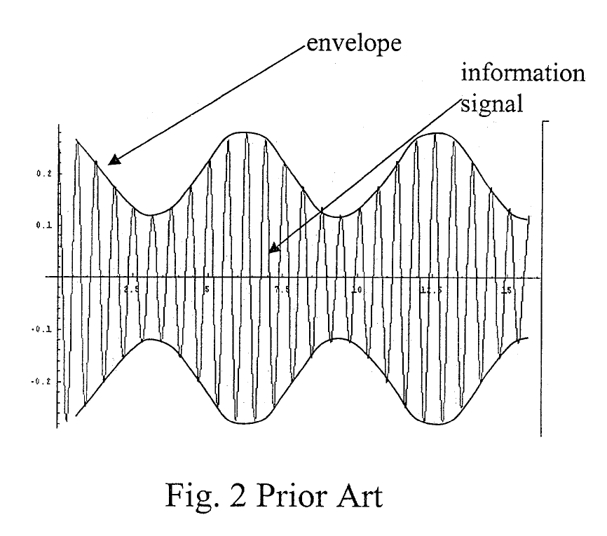

FIG. 3 represents a combination of the information signal with the dither signal according to the present invention,

FIGS. 4a-4c show voltage waveforms of the monitored signal according to the invention, respectively when the bias is too high (FIG. 4a), at correct bias (FIG. 4b) and when the bias is too low (FIG. 4c),

FIGS. 5a-5c show voltage waveforms produced by the monitor receiver after highpass filtering that excludes signal components in the range of the dither signal, respectively for bias too high (FIG. 5a), bias correct (FIG. 5b) and bias too low (FIG. 5c),

FIG. 6 illustrates an amplitude demodulation circuit of the highpass filter of rectify-and-integrate type that can process the monitor signal to obtain waveforms that can be used for bias correction,

FIG. 7 shows the outputs of the circuit of FIG. 6 for bias too high, bias correct, and bias too low,

FIG. 8a illustrates a Mach Zehnder interferometer having input terminals on which to apply a voltage arranged in series along a same waveguide;

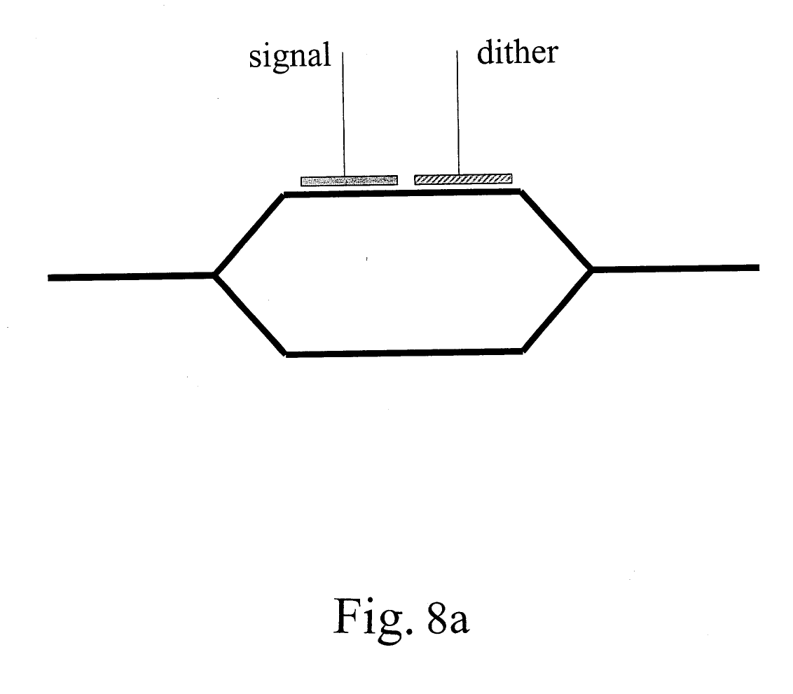

FIG. 8b illustrates a Mach-Zehnder interferometer having input terminals on which to apply a voltages arranged along different waveguides; and

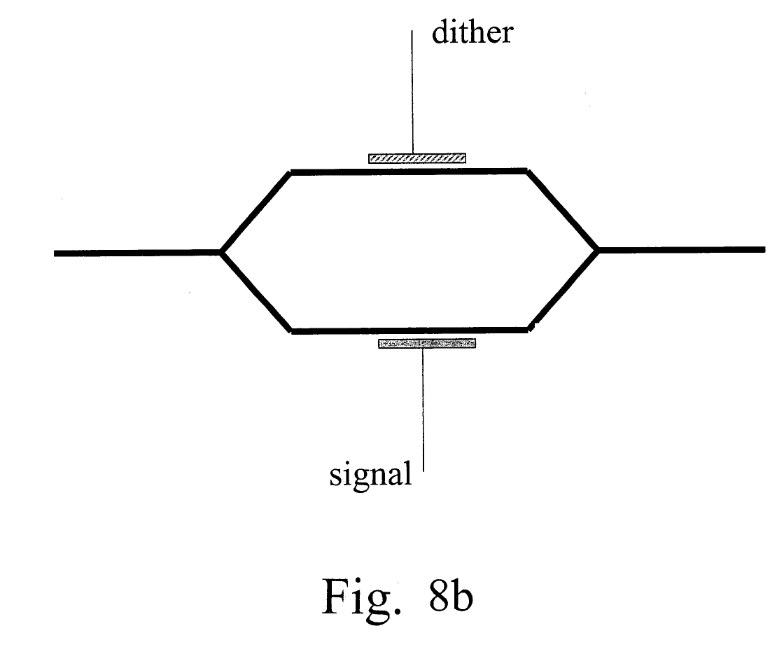

FIG. 8c illustrates a modulator wherein an information signal and a periodic dither signal are added together and subsequently provided as a summed voltage signal to a pair of terminals on of the waveguides of the interferometer.

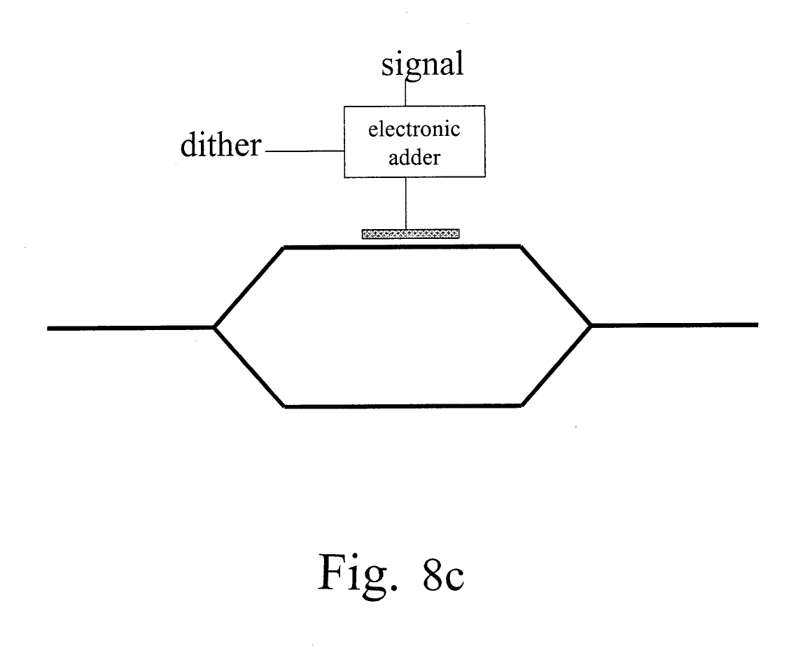

### DETAILED DESCRIPTION OF THE INVENTION

In the inventive method and apparatus for maintaining correct bias, a dither signal is introduced into the optical signal that is output from the modulator. This composite signal is detected by tapping off a portion of the modulated light, and monitored in the output of an optical receiver that receives the tapped light. By suitable processing of the detected portion of the signal output from the modulator the information required to determine whether the bias is correct, and how to alter the bias voltage if it is not, is obtained and used to control the bias voltage.

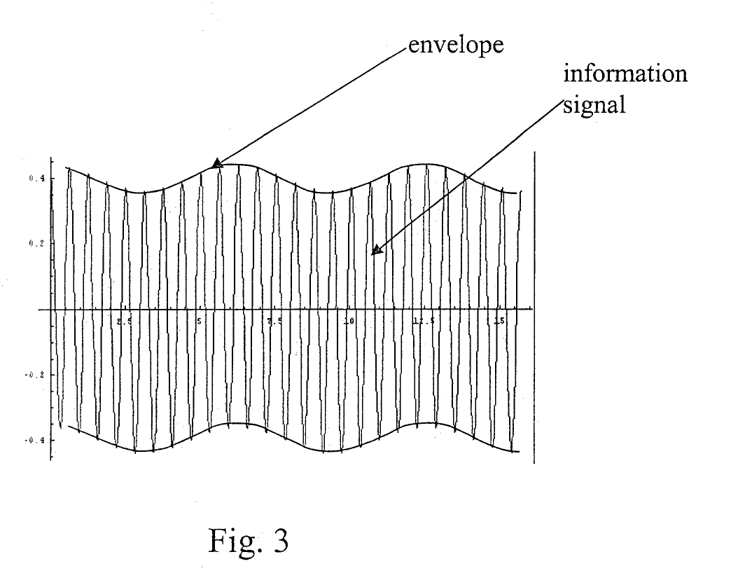

Contrary to prior art, the dither signal is imposed on the optical information signal in such a way that the envelope is modulated in the same phase at both its upper and lower edges, as shown in FIG. 3. Such a modulation can be obtained by adding the dither signal to the information signal rather than by modulating the information signal with the dither signal as in prior art. The process of addition can be performed electronically and the sum of the two signals can be applied to the modulator as a single drive signal. Alternatively, and more simply, the dither signal can be separately applied to the modulator in such a way that the phase shifts induced by the signal and dither have a linearly combined effect on the phase shift induced in the two paths of the interferometer. Such a separate application of signals can be achieved, for example, by applying the signals to separate electrodes.

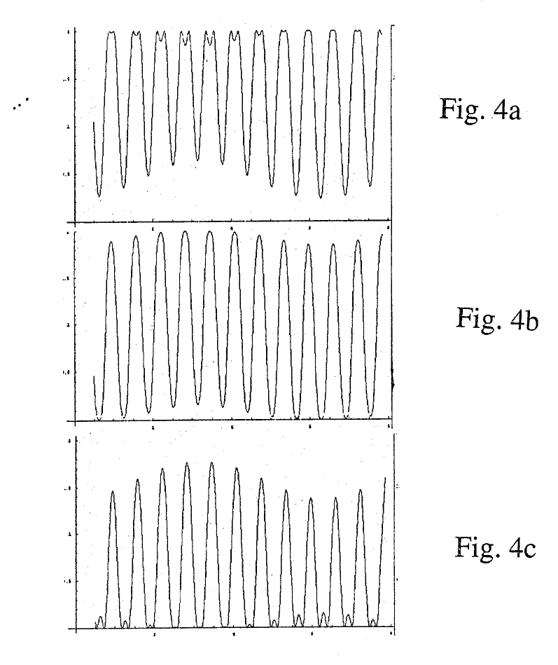

When the bias point is correct the information component in the monitored signal varies around an average power level that moves up and down sinusoidally at the dither frequency. When the bias point is too high, the information waveform is clipped or even inverted at its upper levels by the nonlinearity of the modulator response. When the bias point is too low, the information waveform is clipped or inverted at its lower levels. Notably, the clipping of the information waveform at high or low levels occur at different times, corresponding to opposite phases of the dither signal. This difference permits the identification of the sign of the error in the bias voltage after appropriate signal processing. Voltage waveforms of the monitored signal are shown in FIGS. 4a-4c for the case of bias being too high (FIG. 4a), correct (4b) and too low (4c).

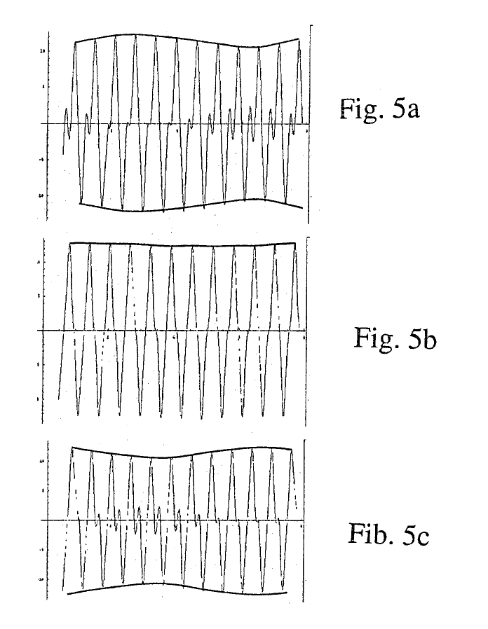

The monitored voltage waveforms such as shown in FIGS. 4a-4c are subjected to highpass filtering that excludes components in the range of the dither signal. The variations in the average level are removed but variations of the peak heights of the data signal that result from clipping are retained. These resulting signals constitute amplitude modulation signals in which amplitude modulation results directly from the nonlinearity of the modulator, in contrast to the amplitude modulation signals of prior art, which are generated before the modulator. Monitor signals 4, 5 and 6 that correspond to signals 1, 2 and 3 after highpass filtering are shown in FIG. 5. Waveform 5 is the signal when the bias is correct, yielding substantially constant peak heights, waveform 4 shows the variation of peak height when the bias is too high and clipping occurs at the upper envelope, and waveform 6 shows the filtered waveform when the bias is too low and the clipping occurs at a different phase of the dither signal.

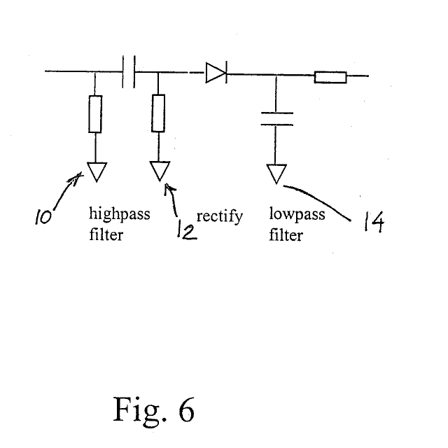

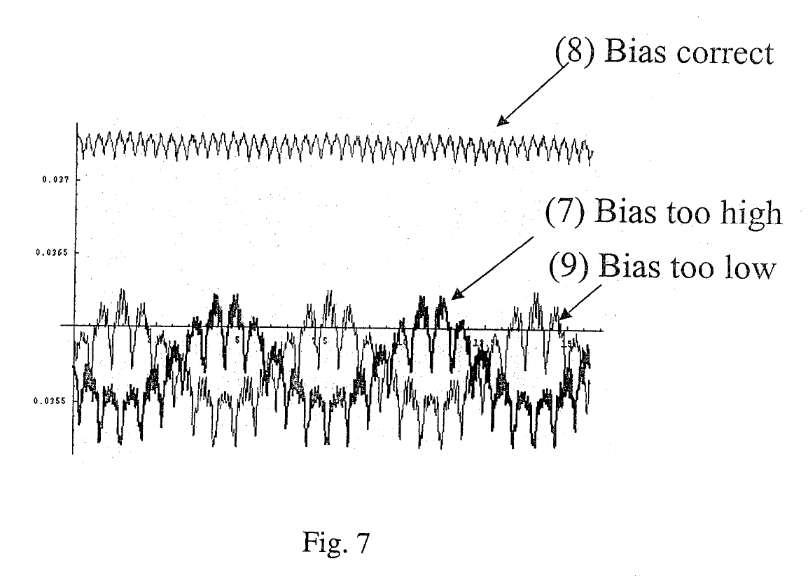

Signals such as shown in FIGS. 5a-5c 6 carry information about the bias condition as amplitude modulation. The information can be recovered from the highpass filtered monitor signal by any of several known methods for detecting amplitude modulation. Homodyne detection against a signal at the information frequency is one possibility. A more simple and practical method is to rectify and integrate the signal by a circuit of the type shown in FIG. 6, the circuit having a highpass filter 10, a rectifying filter 12 and a lowpass filter 14. The output of such a circuit is shown in FIG. 7 for the three bias cases discussed above. If the bias is correct (8) the signal is essentially constant at a maximum average level (a small variation may occur at the information signal rate). If the bias is incorrect the signal has a lower average value and contains a component at the dither frequency, in one phase (7) for bias too high and the other (9) for bias too low. The phase of the error signal can be determined by comparison with the dither signal applied to the modulator.

The average value, modulation amplitude and phase of the dither signal can be detected by various methods of signal processing. Sampling this signal and digitally determining average, amplitude and phase is possible because the dither signal can be reasonably slow. Alternatively, homodyne detection of amplitude and phase of the dither signal in the output of the monitor may be used.

The voltage bias of the optical modulator is correct if the component in the monitor signal at the dither frequency is minimal and the average value of the signal is maximal. The bias should be increased if the average drops below a threshold, and/or a component at the dither frequency appears. The bias should be increased if the phase of the dither frequency component corresponds to an insufficient bias condition, or reduced if the phase is opposite.

The inventive method of combining the information signal and the dither signal can be accomplished by simpler components than needed for the prior art. Linear combination, i.e. addition or subtraction, of the information and dither signals is required. Such linear combination can be achieved by low frequency electronic circuits only capable of handling the dither frequency without the need for electronic multiplier circuits. For example, variation of the modulator bias at the dither frequency accomplishes this goal. Unlike the prior art the dither signal can be applied to the information signal directly in the optical modulator itself by including a separate electrode or other method of phase control that responds only to the dither. The addition of phase differences applied by two separate phase controllers will result in the linear combination of the corresponding signals appearing as the modulation on the light. This method considerably simplifies the electronics necessary for the control of bias point.

Numerous other embodiments of the invention will occur to those skilled in the art, and the invention is to be defined solely by the appended claims.

What is claimed is:

1. A method of controlling a modulator having control circuitry, comprising the steps of:
providing a dither signal to one of the modulator and control circuitry coupled to the modulator;
providing an information signal, to one of the modulator and control circuitry coupled to the modulator, summing the dither signal and an information signal to yield a control signal; and,
utilizing at least a portion the control signal to control the modulator in a feed-back loop.

2. A method as defined in claim 1, wherein the dither signal is a periodic signal and wherein in the information signal is a non-periodic signal containing information.

3. A method as defined in claim 1 wherein the modulator includes a interferometer having an input port at one end, an output port at an opposite end, and two branching optical waveguides therebetween, optically coupled to the input and output ports, and wherein the information signal and the dither signal are provided to one or more of the branching waveguides of the interferometer prior to being added together;

4. A method as defined in claim 1, wherein the modulator includes a interferometer having an input port at one end, an output port at an opposite end, and two branching optical waveguides therebetween, optically coupled to the input and output ports, and wherein the information signal and the dither signal are provided to the interferometer after to being added together;

5. A method as defined in claim 3 wherein the information signal and the dither signal are provided to a same waveguide of the interferometer.

6. A method as defined in claim 3, wherein the information signal is provided to one waveguide of the branching waveguides and the wherein the dither signal is provided to a different waveguide of the branching waveguides.

7. A method as defined in claim 1, wherein at least a portion of the summing signal is tapped after propagating though an output port of the modulator and wherein information in said portion or a portion thereof is used as a feedback signal to control the modulator.

8. An optical modulator comprising:
an optical interferometer having first and second branch paths between and optically coupled with an input port and an output port;
first electronic means for varying an optical path length between the input port and the output port in dependence upon an information signal;
second electronic means of varying an optical path length between the input port and the output port in dependence upon a dither signal.;
wherein variations of optical path length produced by first electronic means and second electronic means combine linearly to produce a net phase difference after combining.

9. An optical modulator as defined in claim 8, wherein the dither signal is a periodic signal, and wherein the information signal is a non-periodic signal.

10. An optical modulator as defined in claim 9, wherein the interferometer is Mach-Zehnder interferometer and wherein the waveguides are an electro-optic material.

11. An optical modulator as defined in claim 10 further comprising a tap for providing a portion of an output signal present at the output port back to the modulator as a feed-back signal.

12. An optical modulator as defined in claim 11, wherein the feedback signal is a at least a portion of the dither signal and the information signal after they have been summed.

13. An optical modulator comprising:
a Mach-Zehnder interferometer having:
an input port for receiving light;
an output port for outputting light;
a first control terminal for receiving a periodic dither signal and for controlling an optical path length of an arm of the interferometer in dependence upon the dither signal;
a second control terminal for receiving a non-periodic information signal and for controlling an optical path length of an arm of the interferometer in dependence upon the non-periodic information signal;
and a tap for tapping and providing a portion of the dither signal and the information signal after they have been summed back to the interferometer to provide control.

14 An optical modulator as defined in claim 8 further comprising a monitoring circuit including:
a) an optical tap for obtaining a portion of an optical power signal exiting the output port
b) an optical receiver for converting the portion of the optical power signal into a received electrical signal
(c) a filter for reducing power in the received electrical signal at frequencies below approximately the frequency of the periodic signal applied to the second electronic means, said filter for providing a received and filtered electronic signal.

15. A optical modulator as in claim 14 further comprising an amplitude modulation detector for detecting an amplitude modulation signal on the received and filtered electronic signal.

16. A monitored optical modulator as in claim 15 wherein the amplitude modulation detector is a homodyne detector.

17. An optical modulator as in claim 15 wherein the amplitude modulation detector is a rectifier coupled with a filter.

18. An optical modulator as in claims 15 wherein the amplitude modulation detector is a digital signal processor.

19. An optical modulator as in claim 15 in which a voltage bias applied to the optical modulator is corrected using information derived from the detected amplitude modulation signal.

20. An optical modulator as defined in claim 15 in which information is derived from the detected amplitude modulation signal by a digital signal processor.

21. A monitored optical modulator as defined in claim 15 in which the detected amplitude modulation signal is homodyned with the periodic signal applied to the second electronic means

22. An optical modulator as in claim 8 in which the periodic signal is applied to the second electronic mans for providing a bias to the optical modulator

23. An optical modulator as in claim 9 in which the periodic and the information signal are each applied to a separate electrodes in series within the optical modulator

24. An optical modulator as in claim 23 in which the separate electrodes are on different paths arms of the interferometer.
